(19) United States
(12) Patent Application Publication
(10) Pub. No.: US 2013/0135076 A1
(43) Pub. Date: May 30, 2013

(54) TRANSFORMER

(71) Applicant: Renesas Electronics Corporation, Kawasaki-shi (JP)

(72) Inventor: Hirokazu NAGASE, Kanagawa (JP)

(73) Assignee: RENESAS ELECTRONICS CORPORATION, Kawasaki-shi (JP)

(21) Appl. No.: 13/680,095

(22) Filed: Nov. 18, 2012

(30) Foreign Application Priority Data
Nov. 25, 2011 (JP) 2011-257936

(51) Int. Cl. H01F 5/00

(52) U.S. Cl. CPC H01F 5/003
USPC 336/220

(57) ABSTRACT

A second inductor is disposed opposite to a first inductor and rotated around the center axis by 180°. The first inductor includes a plurality of lines concentrically formed in a first wiring layer, and a first intersection that is formed in a first area and connects a first line with a second line. The first intersection includes a first connection line formed in a second wiring layer, and a first interlayer line connecting the first and second lines with the first connection line. The second inductor includes a plurality of lines concentrically formed in a third wiring layer, and a second intersection that is formed in a second area and connects a third line with a fourth line. The second intersection includes a second connection line formed in a fourth wiring layer, and a second interlayer line connecting the third and fourth lines with the second connection line.

### CROSS-REFERENCE TO RELATED APPLICATIONS

This application is based upon and claims the benefit of priority from Japanese patent application No. 2011-257936, filed on Nov. 25, 2011, the disclosure of which is incorporated herein in its entirety by reference.

### BACKGROUND

The present invention relates to a transformer.

When data communication is performed between circuits having significantly different signal voltage levels, an isolator, for example, is used in order to ensure the isolation between the circuits. For such an isolator, a transformer, for example, is used for the signal transmission. In such cases, the isolator is required to be capable of suppressing the common mode noise, which is caused when a signal change on the high-voltage side propagates from the transmission side to the reception side through a capacitive coupling of transmission/reception inductors or a capacitance with the substrate. Further, the isolator is also required to be capable of ensuring the withstand voltage between the transmission/reception inductors.

To suppress the common mode noise, it is effective to form a transformer by using inductors having a high electrical symmetry and to use a differential output. Further, it is also effective to reduce the size of the transformer and thereby reduce the parasitic capacitance.

An example of a transformer in which the above-described differential output can be used is explained (Japanese Unexamined Patent Application Publication No. 2010-10344). FIG. 16 is a plane view showing a wiring configuration of a typical symmetry-type inductor 601. Using the symmetry axis passing through the middle point between ports P1 and P2 of the inductor as the border, a line is wired from one of the ports in such manner that the line is shifted to the inner side every time the line goes half round. Further, the line goes round in the innermost part, and then the line is shifted to the outer side every time the line goes half round so that the line reaches the other port. In the places in each of which two of the lines W61 to W64 intersect each other, the line is bypassed by using a different wiring layer(s). The point A in FIG. 16 is a symmetry point in terms of the electric characteristic, and the impedances from the symmetry point to both ports are roughly equal to each other. By disposing two inductors each having this configuration opposite to each other, it is possible to form a transformer. Further, by disposing a center tap at the symmetry point of the reception-side inductors of two sets of transformers, it is possible to form a differential circuit. This makes it possible to suppress the common mode noise.

Each of the intersections 61 to 63 connects different lines with each other. FIG. 17 is a perspective view showing a structure of the intersection 61 of the symmetry-type inductor 601. In the intersection 61, lines W61 and W62 are formed in an upper layer and a connection line CW61 is formed in a lower layer. By forming a continuous line in the upper layer, the lines W61 and W62 are connected. Further, the lines W61 and W62 are connected through interlayer lines VW61 and the connection line CW61.

Meanwhile, in the cases where the differential output is not used, a transformer formed by using the so-called spiral-type inductor (Japanese Unexamined Patent Application Publications No. 3-89548, No. 11-154730, No. 8-45739, and No. 6-120048) is used. FIG. 18 is a plane view showing a wiring configuration of a typical spiral-type inductor 701. In the spiral-type inductor, a line W that constitutes the inductor is disposed in a spiral pattern, and thereby forming a coil having ports P1 and P2.

Further, as a technique for ensuring the withstand voltage (isolation reliability), a wiring film structure for preventing the dielectric breakdown at the interface between buried lines has been proposed (Japanese Unexamined Patent Application Publication No. 2007-123779). In wiring layers and the like, it is necessary to ensure not only the withstand voltage between different layers but alto the withstand voltage between different areas in the same layer (hereinafter called “intra-layer withstand voltage”). According to this structure, it is possible to prevent the dielectric breakdown at the CMP (Chemical Mechanical Polishing) interface of a Cu line formed by Damascene method. That is, it is possible to suppress the intra-layer dielectric breakdown in a laminated structure.

### SUMMARY

However, the present inventors have found that a problem explained below occurs when a transformer is formed by using the above-described inductor. When an inductor is formed by using a wiring layer, it is necessary to take the dielectric breakdown between different areas in the same layer (hereinafter called “intra-layer dielectric breakdown”) into account in order to achieve a satisfactory withstand voltage as described above.

When a transformer is formed by using two symmetry-type inductors 601, main wiring layers are disposed so that they are apart from each other in order to ensure the withstand voltage between different layers. Further, to ensure the intra-layer withstand voltage, it is conceivable that intersections are disposed so that they are apart from each other as much as possible. In this case, it is effective to dispose transformers in such a manner that one of the transformers is rotated by 90° with respect to the other transformer. FIG. 19 is a plane view showing a configuration example of a transformer 600 formed by using two symmetry-type inductors 601 and 602. The transformer 600 has such a structure that the symmetry-type inductor 601 is put on top of the symmetry-type inductor 602 that is rotated by 90°. The symmetry-type inductor 602 has a structure that is obtained by replacing the upper layer of the symmetry-type inductor 601 with its lower layer. The lines W65 to W68 of the symmetry-type inductor 602 correspond to the line W61 to W64 of the symmetry-type inductor 601. The intersections 64 to 66 of the symmetry-type inductor 602 correspond to the intersections 61 to 63 of the symmetry-type inductor 601. The ports P3 and P4 of the symmetry-type inductor 602 correspond to the ports P1 and P2 of the symmetry-type inductor 601. The connection line CW62 and the interlayer line VW62 of the intersections 64 to 66 correspond to the connection line CW61 and the interlayer line VW61, respectively, of the intersections 61 to 63. That is, in the symmetry-type inductor 602, the connection line CW62 is formed in the upper layer and the lines W65 to W68 are formed in the lower layer.

FIG. 20 is a cross section taken along the line XX-XX of FIG. 19, and shows a cross-sectional structure of the transformer 600. The transformer 600 includes four wiring layers L61 to L64, and insulating layers (not shown) that electrically isolate each wiring layer. The lines W61 to W64 of the symmetry-type inductor 601 are formed in the uppermost wiring layer L64. The connection line CW61 is formed in the wiring layer L63, which is immediately below the wiring layer L64. The interlayer line VW61 pierces through the insulating layer, and thereby connects the line W61 with the connection line CW61 and connects the line W62 with the connection line CW61. The wiring layer L64 corresponds to the above-described main wiring layer.

The lines W65 to W68 of the symmetry-type inductor 602 are formed in the lowermost wiring layer L61. The connection line CW62 is formed in the wiring layer L62, which is immediately above the wiring layer L61. The interlayer line VW62 pierces through the insulating layer, and thereby connects the line W65 with the connection line CW62 and connects the line W66 with the connection line CW62. The wiring layer L61 corresponds to the above-described main wiring layer.

That is, in the transformer 600, the horizontal distance between the intersections 61 and 64 is about ½^{1/2} of the internal diameter D of the inductor. When the internal diameter D of the transformer (inductor) is small, the distance between the intersecting lines of the opposing two inductors becomes smaller. Therefore, there is a possibility that the intra-layer withstand voltage (the insulating layer between the wiring layers L62 and L63) becomes predominant. Therefore, the internal diameter should be increased in order to ensure a satisfactory withstand voltage.

However, when the internal diameter is increased, the size of the transformer (inductor) becomes larger, thus causing tradeoffs such as a deteriorated tolerance to the common mode noise due to the increase in the parasitic capacitance and an increase in the chip size. Therefore, typical symmetry-type inductors are unsatisfactory to form a transformer having a satisfactory withstand voltage.

Further, when the differential signal is used, the transformer (inductor) needs to have a high electrical symmetry. Although this can be achieved by using typical symmetry-type inductors, it is disadvantageous in terms of the withstand voltage as described above. Meanwhile, although the spiral-type inductor has an excellent withstand voltage, it has a poor electrical symmetry.

That is, it is very difficult to form a transformer that satisfies both the electrical symmetry and the withstand voltage by using the proposed typical symmetry-type inductors and spiral-type inductors described above.

A first aspect of the present invention is a transformer including: a first inductor; and a second inductor disposed so as to be opposed to the first inductor, the second inductor being rotated around a center axis by 180° with respect to the first inductor, in which the first inductor includes: a plurality of lines concentrically formed in a first wiring layer, the plurality of lines having an opened ring shape; and a first intersection formed in a first area, the first area being one of two areas divided by a line passing through a center axis of the first and second inductors, the first intersection connecting a first line among the plurality of lines of the first inductor with a second line located two lines outside the first line, the first intersection includes: a first connection line formed in a second wiring layer below the first wiring layer; and a first interlayer line that connects the first line with the first connection line and connects the second line with the first connection line, in an innermost first intersection, an innermost line and a line immediately outside the innermost line are formed in the first wiring layer in a continuous manner, the second inductor includes: a plurality of lines concentrically formed in a third wiring layer below the second wiring layer, the plurality of lines having an opened ring shape; and a second intersection formed in a second area, the second area being another of the two areas divided by the line passing through the center axis of the first and second inductors, the second intersection connecting a third line among the plurality of lines of the second inductor with a fourth line located two lines outside the third line, the second intersection includes: a second connection line formed in a fourth wiring layer between the second wiring layer and the third wiring layer; and a second interlayer line that connects the third line with the second connection line and connects the fourth line with the second connection line, and in an innermost second intersection, an innermost line and a line immediately outside the innermost line are formed in the third wiring layer in a continuous manner. According to this transformer, it is possible to provide a sufficiently space between the first and second intersections, and thereby ensure the intra-layer withstand voltage of the layer located between the first and fourth wiring layers. Further, since each line can be connected to the next line but one, it is possible to ensure a higher electrical symmetry than that of a transformer formed by using a spiral-type inductor(s).

According to the present invention, it is possible to provide a transformer having a high withstand voltage and a high electrical symmetry.

### BRIEF DESCRIPTION OF THE DRAWINGS

The above and other aspects, advantages and features will be more apparent from the following description of certain embodiments taken in conjunction with the accompanying drawings, in which:

FIG. 1 is a block diagram showing a configuration of a motor drive system MDS that drives a motor;

FIG. 2 is a plane view showing a structure of an inductor 101 of a transformer 100 according to a first embodiment;

FIG. 3A is a plane view showing a line W11 of an inductor 101;

FIG. 3B is a plane view showing a line W12 of an inductor 101;

FIG. 3C is a plane view showing a line W13 of an inductor 101;

FIG. 3D is a plane view showing a line W14 of an inductor 101;

FIG. 4A is a perspective view showing an intersection 11 of an inductor 101;

FIG. 4B is a perspective view showing an intersection 12 of an inductor 101;

FIG. 4C is a perspective view showing an intersection 13 of an inductor 101;

FIG. 5 is a plane view showing a structure of a transformer 100 according to a first embodiment;

FIG. 6 is a cross section taken along the line VI-VI of FIG. 5, and shows a cross-sectional structure of a transformer 100;

FIG. 7 is a plane view showing a schematic structure of an inductor for examining impedances of an inductor;

FIG. 8A is a schematic diagram showing impedances in a path extending from a port P1 to a port P2 of a spiral-type inductor 701;

FIG. 8B is a schematic diagram showing impedances in a path extending from a port P2 to a port P1 of a spiral-type inductor 701;

FIG. 9A is a schematic diagram showing impedances in a path extending from a port P1 to a port P2 of an inductor 101;

FIG. 9B is a schematic diagram showing impedances in a path extending from a port P2 to a port P1 of an inductor 101;

FIG. 10 is a plane view showing a structure of an inductor 201 of a transformer 200 according to a second embodiment;

FIG. 11 is a plane view showing a structure of a transformer 200 according to a second embodiment;

FIG. 12 is a plane view showing a structure of a transformer 300 according to a third embodiment;

FIG. 13 is a cross section taken along the line XIII-XIII of FIG. 12, and shows a cross-sectional structure of a transformer 300;

FIG. 14 is a plane view showing a structure of an inductor 401 of a transformer 400 according to a fourth embodiment;

FIG. 15 is a plane view showing a structure of an inductor 501 of a transformer 500 according to a fifth embodiment;

FIG. 16 is a plane view showing a wiring configuration of a typical symmetry-type inductor 601;

FIG. 17 is a perspective view showing an intersection 61 of an inductor 601;

FIG. 18 is a plane view showing a wiring configuration of a typical spiral-type inductor 701;

FIG. 19 is a plane view showing a configuration example of a transformer 600 formed by two symmetry-type inductors 601 and 602; and

FIG. 20 is a cross section taken along the line XX-XX of FIG. 19, and shows a cross-sectional structure of a transformer 600.

### DETAILED DESCRIPTION

Embodiments according to the present invention are explained hereinafter with reference to the drawings. The same symbols are assigned to the same components throughout the drawings, and their duplicated explanation is omitted as appropriate.

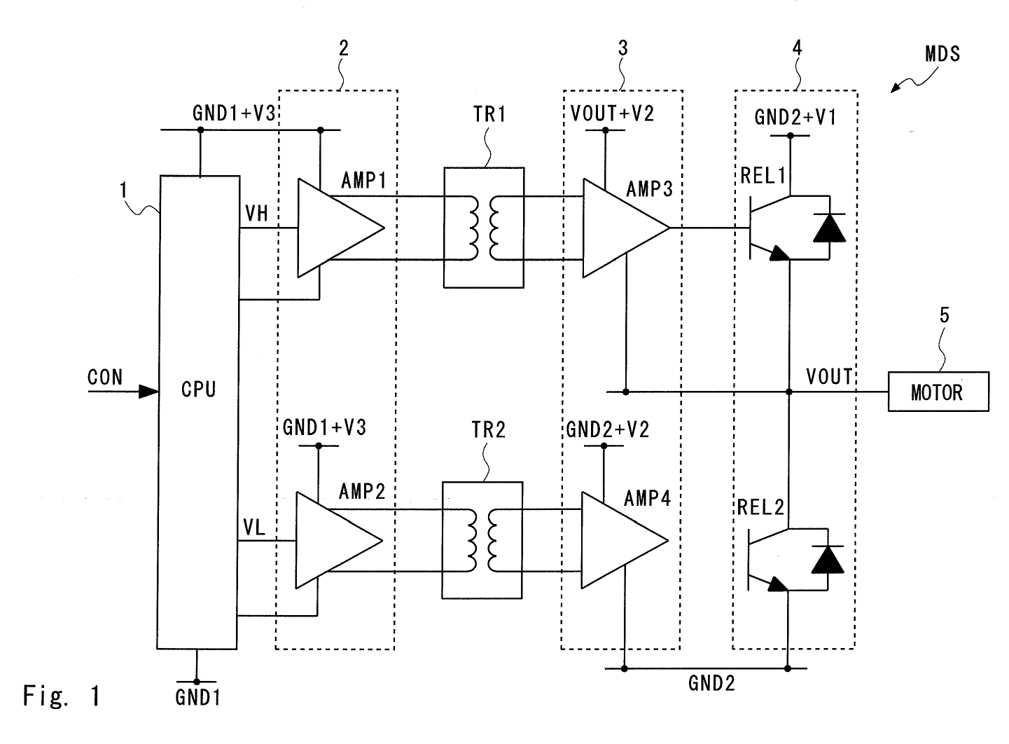

Firstly, as a premise to understand the technical meaning of a transformer according to the present invention, an example of a usage state of a transformer is explained. FIG. 1 is a block diagram showing a configuration of a motor drive system MDS that drives a motor. The motor drive system MDS includes a CPU 1, a level shift unit 2, transformers TR1 and TR2, a gate drive unit 3, a drive unit 4, and a motor 5. In general, a high voltage is required to drive the motor 5. Therefore, in the motor drive system MDS, the power supply voltage that is applied to the gate drive unit 3, the drive unit 4, and the motor 5 (hereinafter referred to as “high-voltage applied section”) is higher than the power supply voltage that is applied to the CPU 1 and the level shift unit 2 (hereinafter referred to as “low-voltage applied section”). The transformers TR1 and TR2 are used to electrically isolate the high-voltage applied section and the low-voltage applied section from each other and thereby prevent the motor drive system MDS from being broken down.

The CPU 1 controls the driving of the motor 5 according to an external control signal CON. A power supply voltage (GND1+V3) and a ground voltage GND1 are applied to the CPU 1, so that the CPU 1 is supplied with electric power. The CPU 1 outputs signals UH and UL to drive the motor 5. Note that the signals UH and UL are a pair of differential signals.

The level shift unit 2 includes amplifiers AMP1 and AMP2. The power supply voltage (GND1+V3) is also applied to the amplifiers AMP1 and AMP2 and their ground terminals are connected to the CPU 1, so that they are supplied with electric power. The amplifier AMP1 outputs a signal obtained by shifting the voltage level of the signal UH to the transformer TR1. The amplifier AMP2 outputs a signal obtained by shifting the voltage level of the signal UL to the transformer TR2.

The transformer TR1 transmits the signal UH to the gate drive unit 3 while maintaining the isolation between the level shift unit 2 and the gate drive unit 3. The transformer TR2 transmits the signal UL to the gate drive unit 3 while maintaining the isolation between the level shift unit 2 and the gate drive unit 3.

The gate drive unit 3 includes amplifiers AMP3 and AMP4. A power supply voltage (GND1+V2) and an output voltage VOUT (as a ground voltage) are applied to the amplifier AMP3, so that it is supplied with electric power. The amplifier AMP3 outputs a signal obtained by amplifying the signal UH to the drive unit 4. The power supply voltage (GND1+V2) and a ground voltage GND2 are applied to the amplifier AMP4, so that it is supplied with electric power. The amplifier AMP4 outputs a signal obtained by amplifying the signal UL to the drive unit 4.

The drive unit 4 includes relays REL1 and REL2. The relay REL1 is connected between a power supply that outputs a power supply voltage (GND1+V1) and a node from which the output voltage VOUT is output. The control terminal of the relay REL1 is connected to the output of the amplifier AMP3, and its On/Off state is thereby controlled. The relay REL2 is connected between a power supply that outputs the power supply voltage GND2 and the node from which the output voltage VOUT is output. The control terminal of the relay REL2 is connected to the output of the amplifier AMP4, and its On/Off state is thereby controlled. In this way, the drive unit 4 outputs the output voltage VOUT to the motor 5.

In the drive unit 4, the relays REL1 and REL2 need to operate in synchronization with each other. Therefore, in the motor drive system MDS, the signals UH and UL, which are differential signals, are used for the control of the relays REL1 and REL2. Accordingly, the transformers TR1 and TR2 are required to have not only a high withstand voltage but also a high electrical symmetry so that the signal quality of the differential signals does not deteriorate.

### First Embodiment

Next, a transformer 100 according to a first embodiment of the present invention is explained. The transformer 100 according to the first embodiment and transformers according to subsequent embodiments may be used in an apparatus or a system requiring a high withstand voltage and a high electrical symmetry as shown in FIG. 1 as an example.

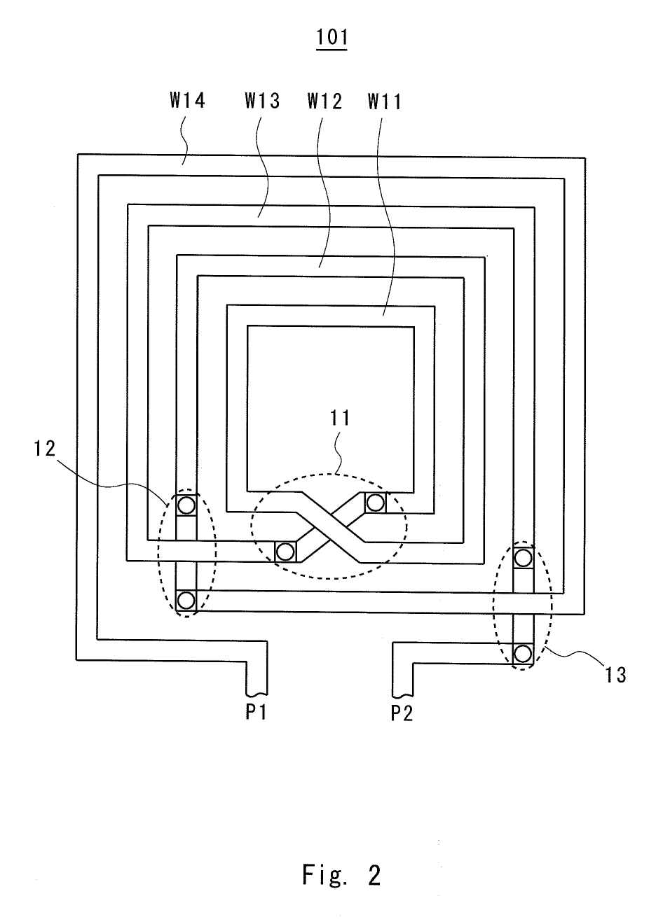

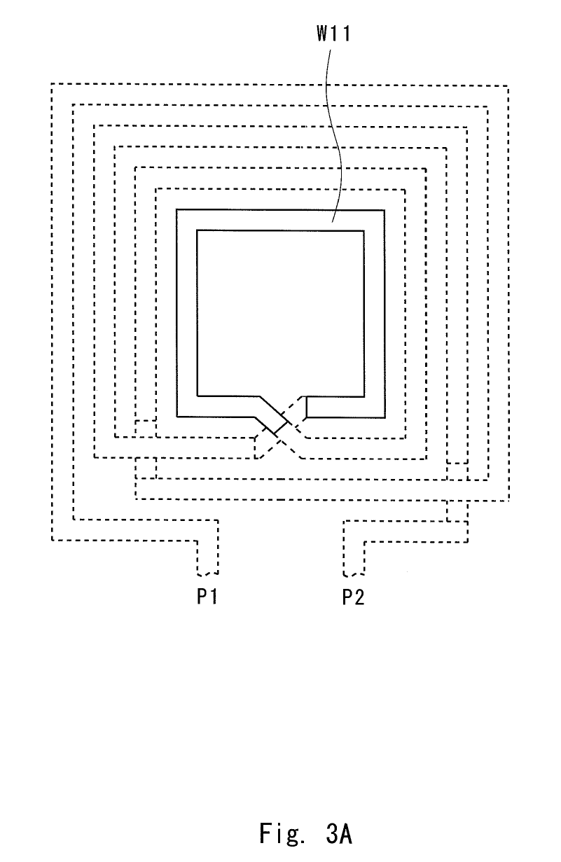

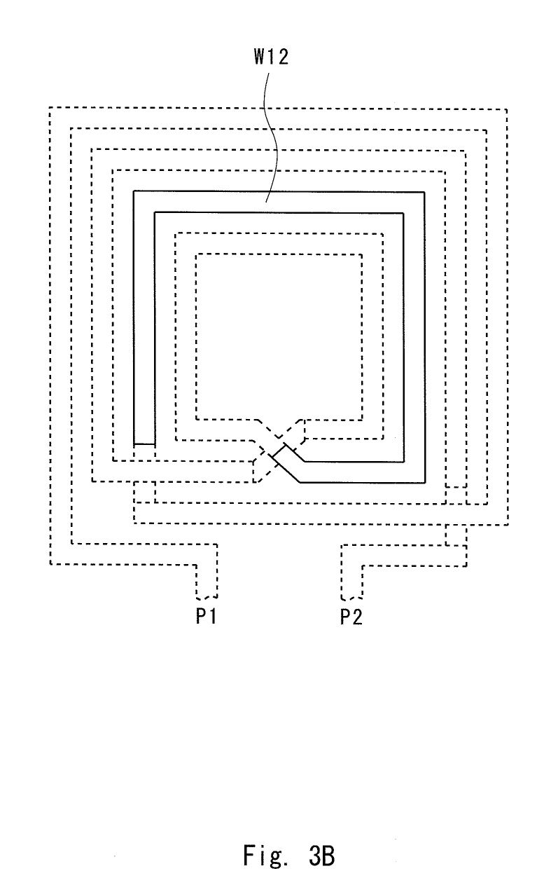

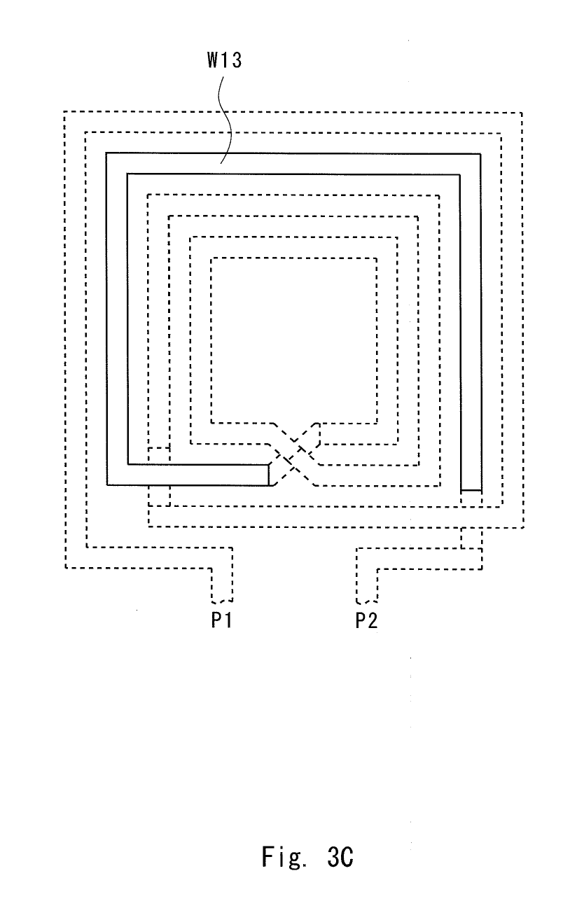

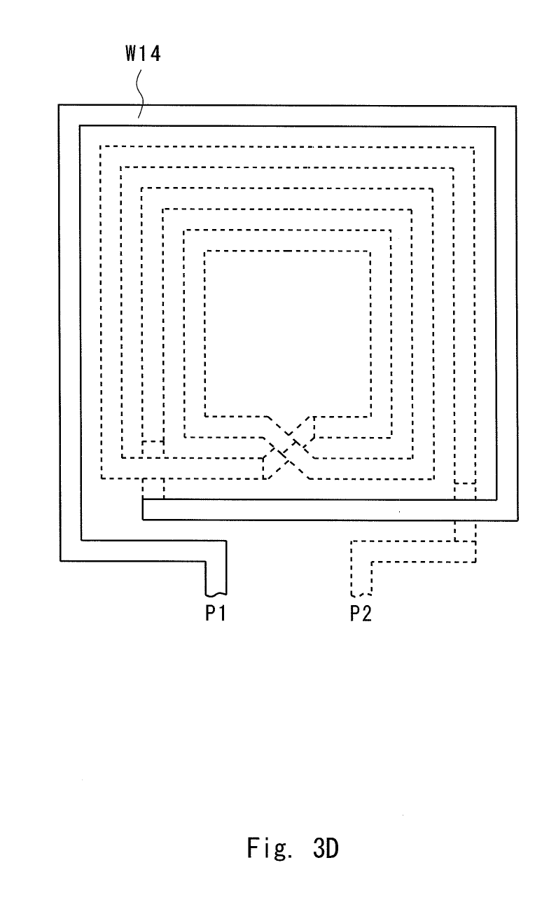

The transformer 100 includes inductors 101 and 102. The inductors 101 and 102 are disposed on top of one another and thereby form one transformer. FIG. 2 is a plane view showing the structure of the inductor 101 of the transformer 100 according to the first embodiment of the present invention. The inductor 101 includes lines W11 to W14 and intersections 11 to 13. FIGS. 3A to 3D are plane view showing the lines W11 to W14, respectively, of the inductor 101. The lines W11 to W14 are concentrically arranged and have an opened ring shape. As an example, an example where the lines W11 to W14 have a square shape is explained with reference to FIGS. 2 and 3A to 3D.

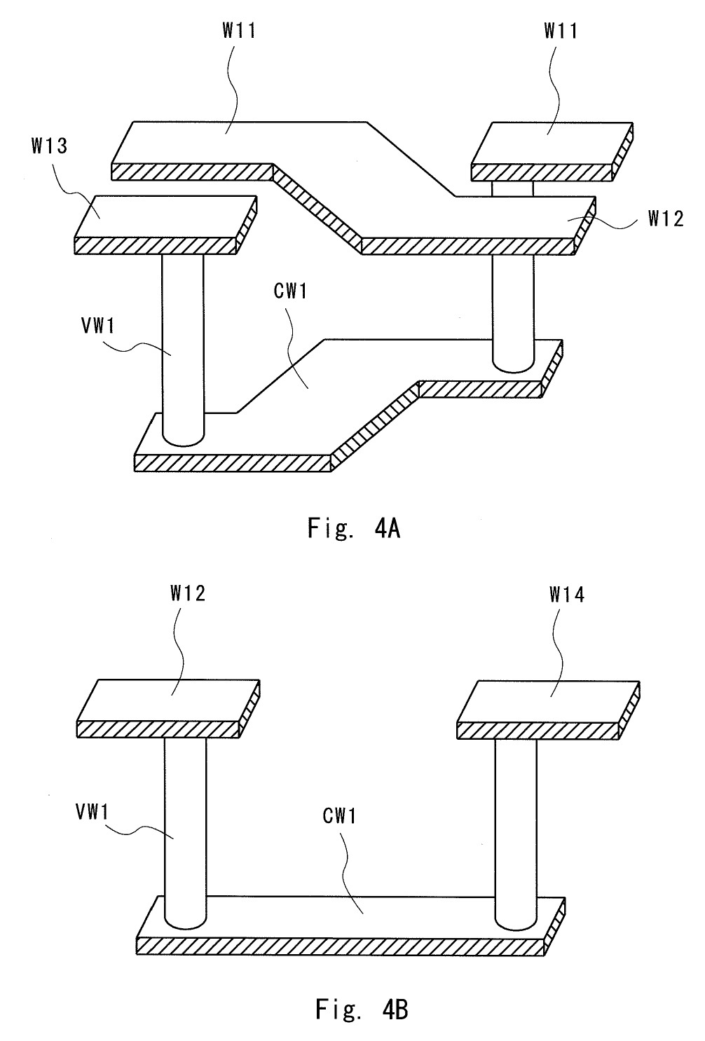

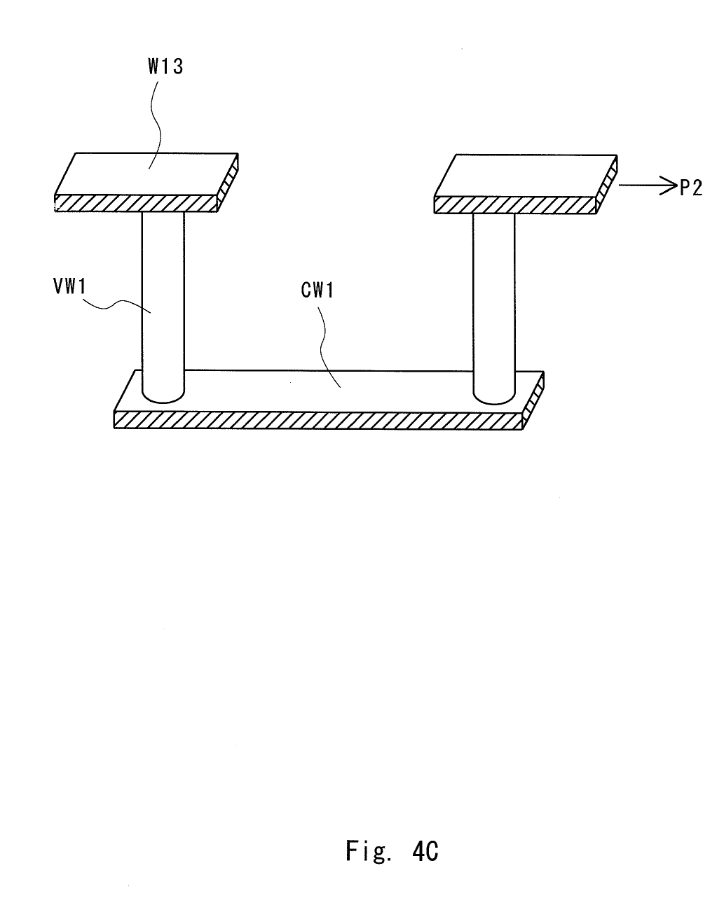

Each of the intersections 11 to 13 connects different lines with each other. FIG. 4A is a perspective view showing the intersection 11 of the inductor 101. In the intersection 11, the lines W11 and W12 are formed in an upper layer and a connection line CW1 is formed in a lower layer. By forming a continuous line in the upper layer, the lines W11 and W12 are connected. Further, the lines W11 and W13 are connected through interlayer lines VW1 and the connection line CW1.

FIG. 4B is a perspective view showing the intersection 12. In the intersection 12, the lines W12 and W14 are formed in the upper layer and a connection line CW1 is formed in the lower layer. The lines W12 and W14 are connected through interlayer lines VW1 and the connection line CW1.

FIG. 4C is a perspective view showing the intersection 13. In the intersection 13, the line W13 and a line connected to the port P2 are formed in the upper layer and a connection line CW1 is formed in the lower layer. The line W13 and the port P2 are connected through interlayer lines VW1 and the connection line CW1.

As a result, an inductor having a path “port P1→line W14→intersection 12→line W12→line W11→intersection 11→line W13→intersection 13→port P2” is formed. In other words, the line W11, which is the innermost line, is connected to a line located immediately outside the innermost line W11, i.e., the line W12 and also connected to a line located two lines outside the innermost line W11, i.e., the line W13. Further, the outermost line W14 is connected to a line located two lines inside the line W14, i.e., the line W12.

Although a case where there are four lines is explained above with reference to FIG. 2, the above-described case is just an example. That is, it is possible to apply the configuration shown in FIG. 2 to other configurations in which there are three or more lines. Note that to ensure the electrical symmetry, the number of lines is preferably an even number. Further, for cases where there are an arbitrary number of lines, the only requirement is that the innermost line should be connected to a line located immediately outside the innermost line and a line located two lines outside the innermost line, and each of the remaining lines should be connected to a line located two lines outside that line.

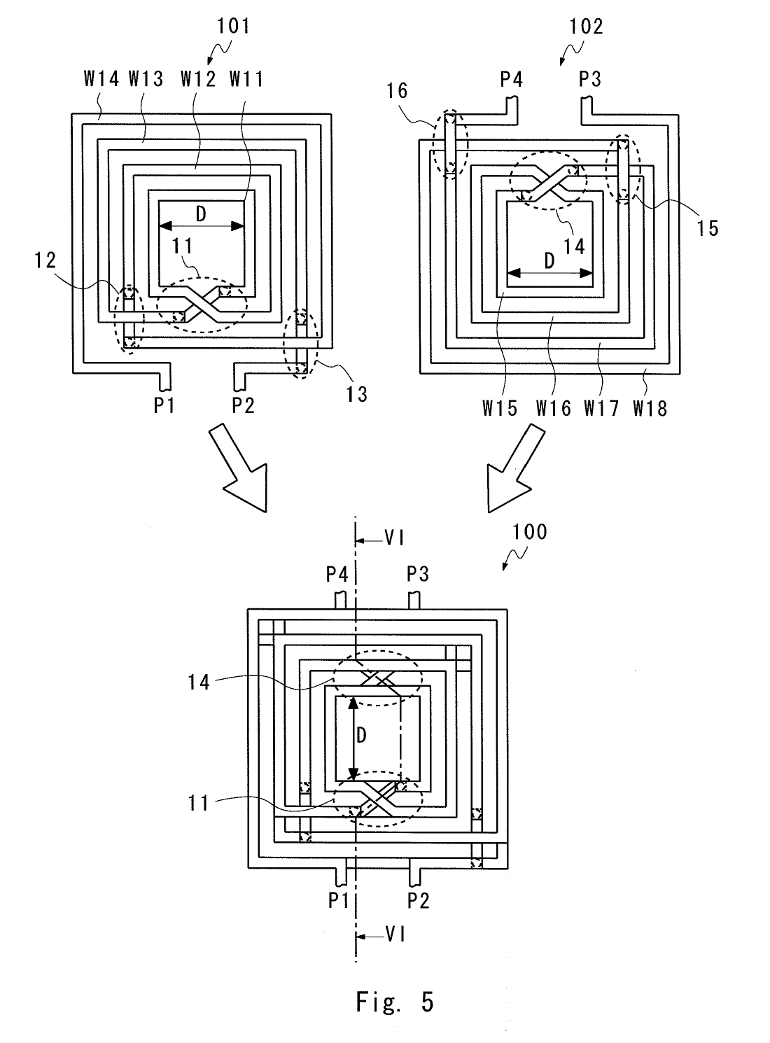

FIG. 5 is a plane view showing a configuration of the transformer 100 according to the first embodiment of the present invention. The transformer 100 has such a structure that the inductor 101 is put on top of the inductor 102, which is rotated by 180°. In this example, the inductors 101 and 102 have the common center axis. The inductor 102 has a structure that is obtained by replacing the upper layer of the inductor 101 with its lower layer. The lines W15 to W18 of the inductor 102 correspond to the line W11 to W14 of the inductor 101. The intersections 14 to 16 of the inductor 102 correspond to the intersections 11 to 13 of the inductor 101. The connection line CW2 and the interlayer line VW2 of the intersections 14 to 16 correspond to the connection line CW1 and the interlayer line VW1, respectively, of the intersections 11 to 13. The ports P3 and P4 of the inductor 102 correspond to the ports P1 and P2 of the inductor 101. That is, in the inductor 102, the connection line CW2 is formed in the upper layer and the lines W15 to W18 are formed in the lower layer.

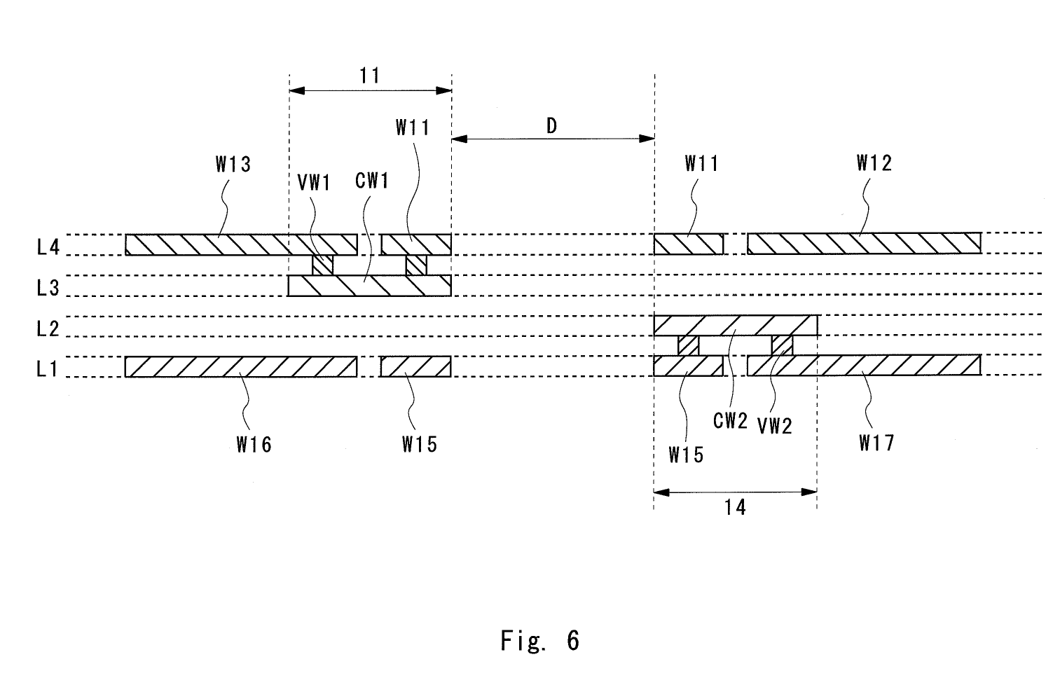

FIG. 6 is a cross section taken along the line VI-VI of FIG. 5, and shows a cross-sectional structure of the transformer 100. The transformer 100 includes four wiring layers L1 to L4, and insulating layers (not shown) that electrically isolate each wiring layer. The lines W11 to W14 of the inductor 101 are formed in the uppermost wiring layer L4. The connection line CW1 is formed in the wiring layer L3, which is immediately below the wiring layer L4. The interlayer line VW1 pierces through the insulating layer, and thereby connects the line W11 with the connection line CW1 and connects the line W13 with the connection line CW1.

The lines W15 to W18 of the inductor 102 are formed in the lowermost wiring layer L1. The connection line CW2 is formed in the wiring layer L2, which is immediately above the wiring layer L1. The interlayer line VW2 pierces through the insulating layer, and thereby connects the line W15 with the connection line CW2 and connects the line W17 with the connection line CW2.

That is, in the transformer 100, it is possible to provide a horizontal space equal to the internal diameter D of the inductor between the intersections 11 and 14. Therefore, it is possible to increase the distance between the intersections in comparison to typical transformers. Accordingly, it is possible to prevent the intra-layer dielectric breakdown, which could otherwise occur in the insulating layer located between the wiring layers L2 and L3.

Note that the above-described arrangement of the intersections is just an example. When a transformer is divided into two areas on a line passing through the center axis of the transformer, the intersections of one of the inductors may be disposed in one of the areas while the intersections of the other inductor may be disposed in the other area.

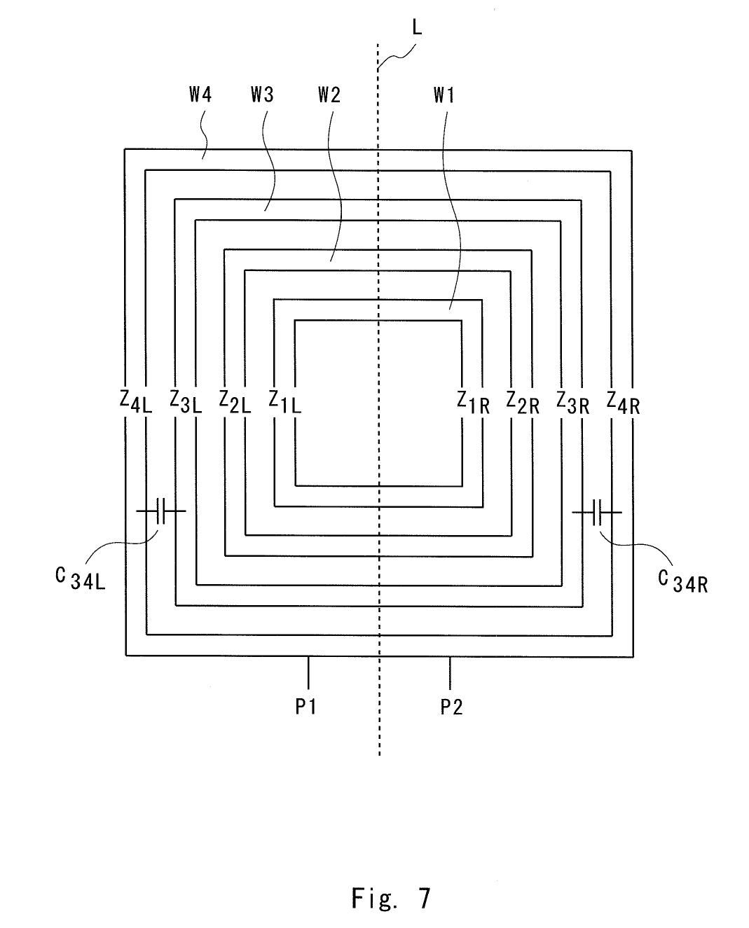

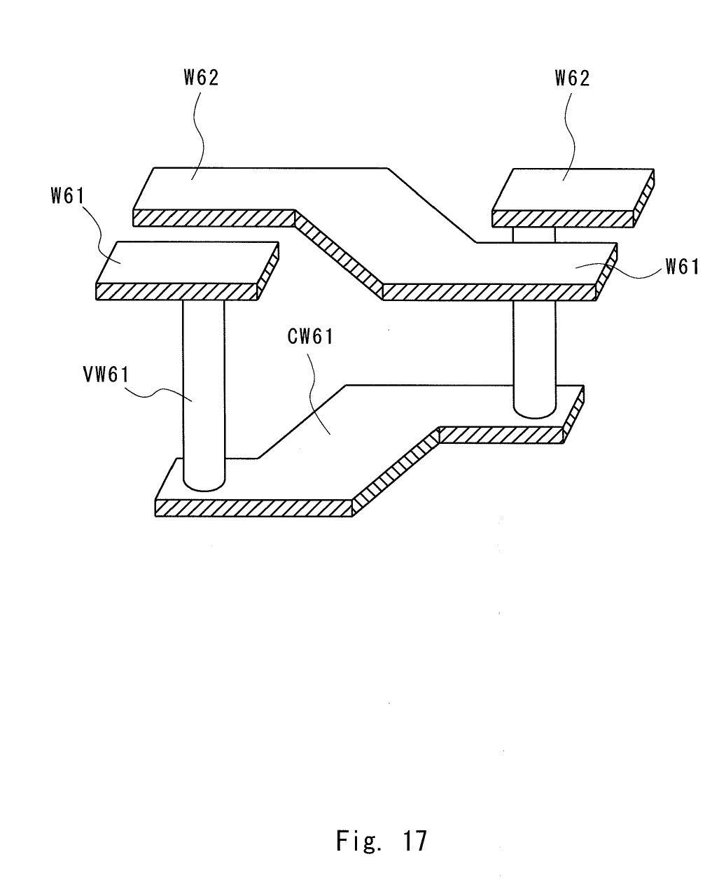

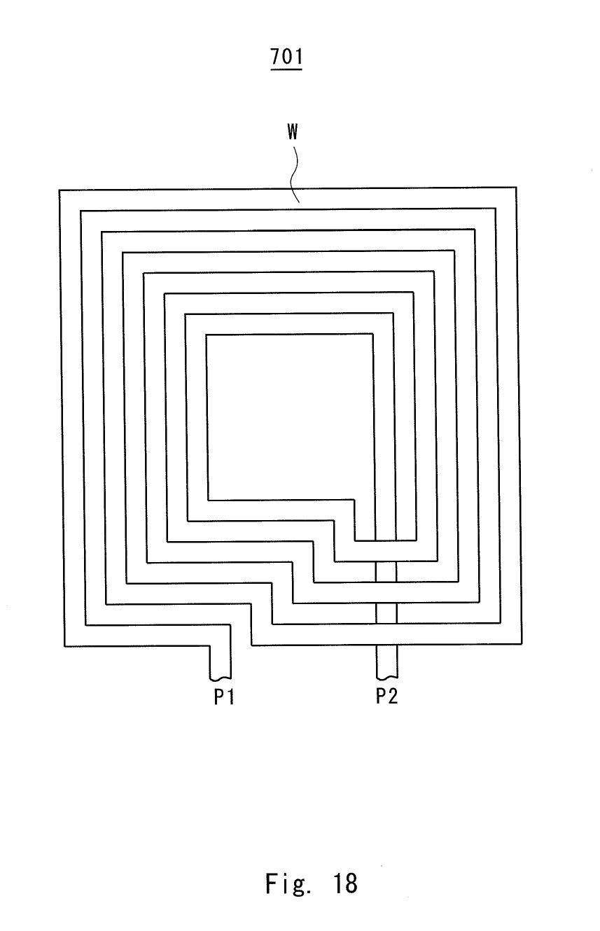

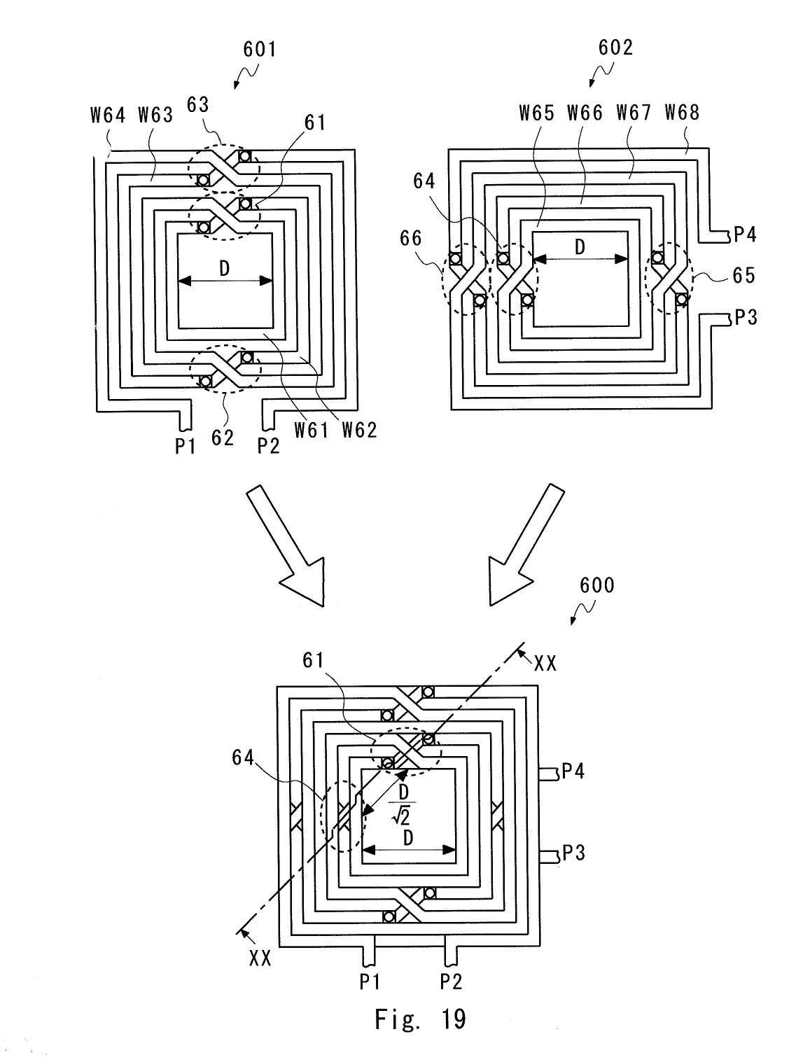

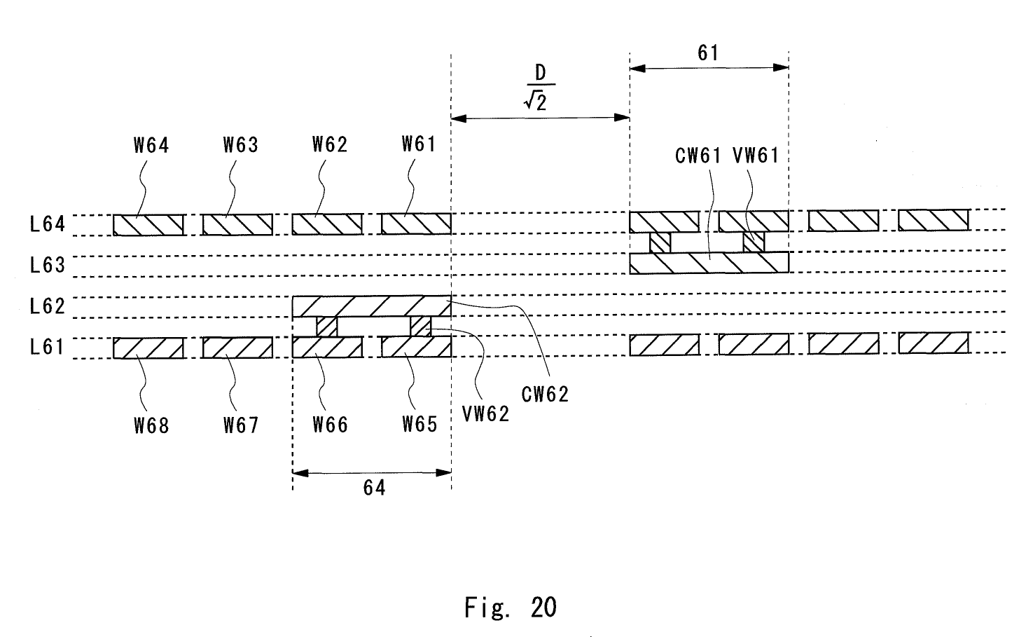

Further, the transformer 100 is composed of inductors in which each line is connected to the next line but one. Therefore, it is possible to improve the electrical symmetry even further in comparison to the case where spiral-type inductors are used. The reason for this improvement is explained below by using the inductor 101 shown in FIG. 1 and the spiral-type inductor 701 shown in FIG. 17 as an example. FIG. 7 is a plane view showing a schematic configuration of an inductor for examining impedances of an inductor. Each of the inductor 101 shown in FIG. 1 and the spiral-type inductor 701 shown in FIG. 17 is an inductor in which the line is wound four times. For simplifying the configuration of the inductor, FIG. 7 shows four-time-wound ring-shape lines W1 to W4. Further, the inductor is divided into left and right sections on the center line L. Further, the impedances of the lines W1 to W4 in the left area are represented by Z1L to Z4L, and the impedances of the lines W1 to W4 in the right area are represented by Z1R to Z4R. Note that under normal circumstances, interactions between lines and other parasitic capacitances also exist in an inductor. Accordingly, FIG. 7 shows a simplified configuration for the sake of examination.

The longer the wiring line is, the lager the main impedance such as an inductance becomes. Therefore, in FIG. 7, it is considered that the relation “Z4L=Z4R>Z3L=Z3R>Z2L=Z2R>Z1L=Z1R” is satisfied. Further, the longer the wiring line is, the larger the parasitic capacitance of the inductor becomes. In this example, only the capacitances C34L and C34R between the lines W3 and W4, which are the largest capacitances, are taken into account.

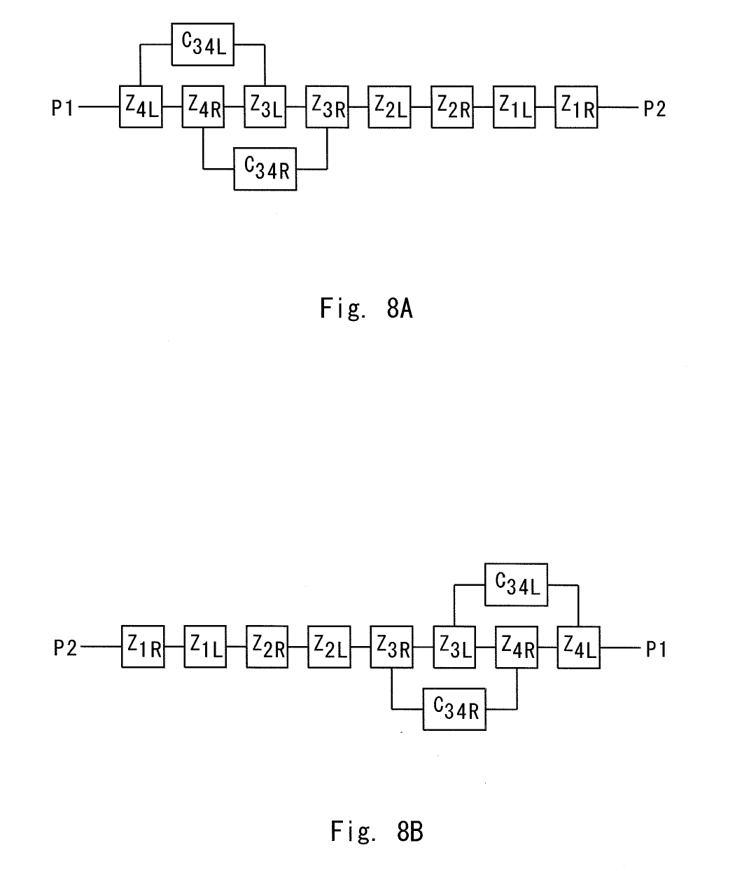

For the inductor 101 and the spiral-type inductor 701, the impedances in a path extending from the port P1 to the port P2 and in a path extending from the port P2 to the port P1 are examined hereinafter. FIG. 8A is a schematic diagram showing the impedances in a path extending from the port P1 to the port P2 of the spiral-type inductor 701. FIG. 8B is a schematic diagram showing the impedances in a path extending from the port P2 to the port P1 of the spiral-type inductor 701. As shown in FIGS. 8A and 8B, in the spiral-type inductor 701, the configuration of the impedances and the capacitances in the path from the port P1 to the port P2 is different from that in the path from the port P2 to the port P1 in terms of the right/left direction, and therefore they are unbalanced.

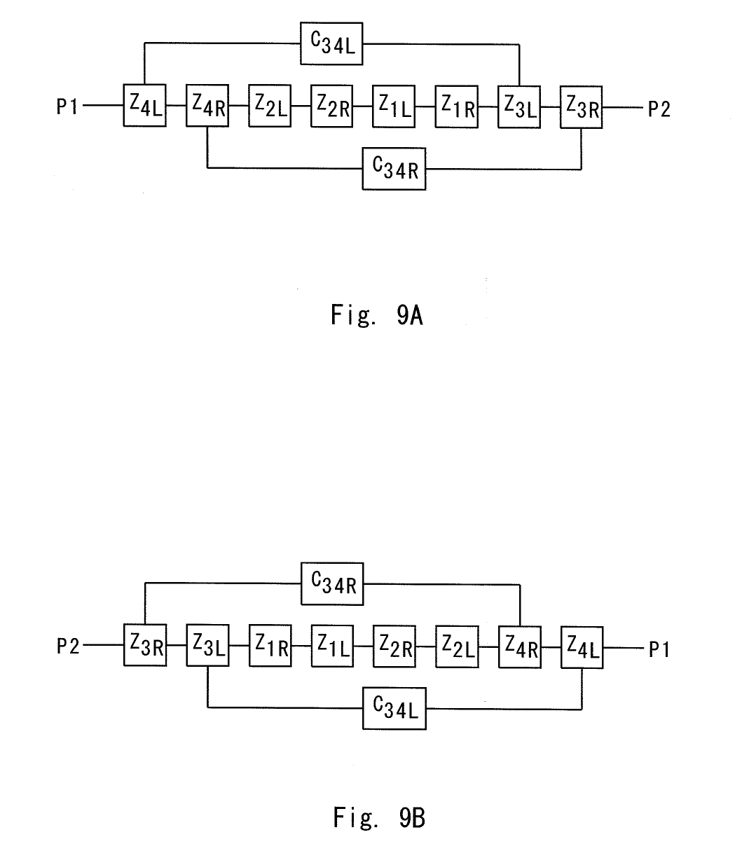

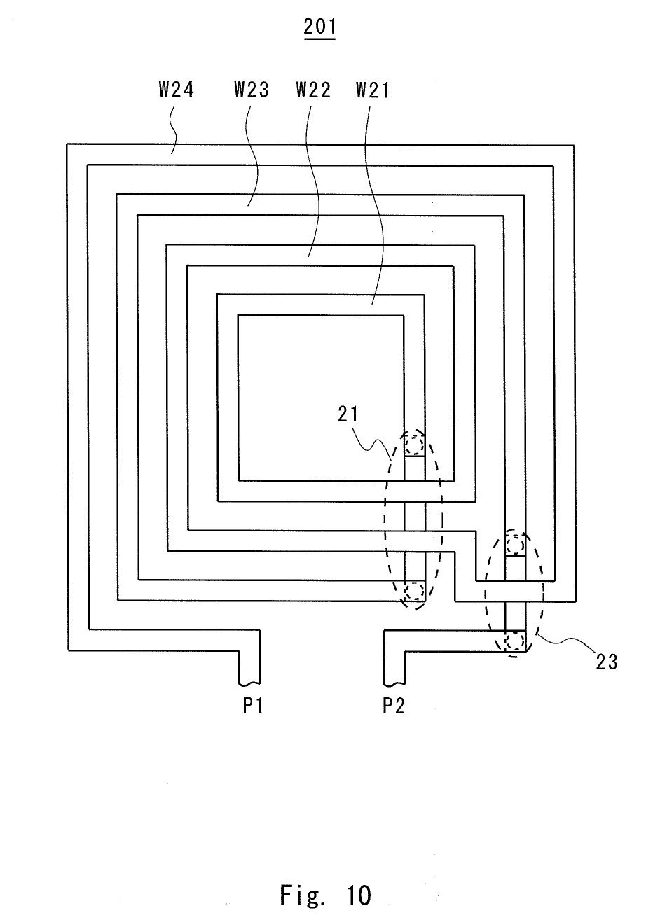

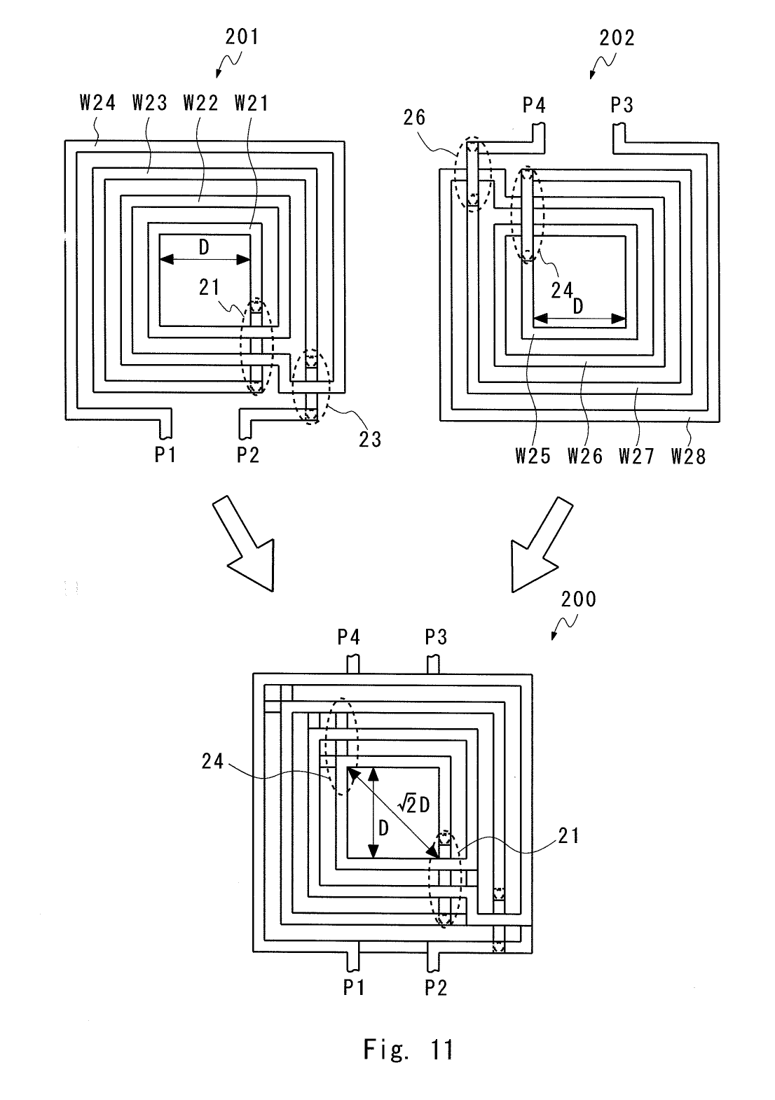

FIG. 9A is a schematic diagram showing the impedances in a path extending from the port P1 to the port P2 of the inductor 101. FIG. 9B is a schematic diagram showing the impedances in a path extending from the port P2 to the port P1 of the inductor 101. As shown in FIGS. 9A and 9B, in the inductor 101, the configuration of the impedances and the capacitances in the path from the port P1 to the port P2 is symmetrical to that in the path from the port P2 to the port P1 in terms of the right/left direction in contrast to the spiral-type inductor 701. Therefore, it can be understood that the impedance variation, which is caused by the difference between paths, is smaller in the inductor 101, and thus the inductor 101 has a better electrical symmetry in comparison to the spiral-type inductor 701.

From these reasons, according to the configuration of this embodiment, it is possible to provide a transformer having a high withstand voltage and a high electrical symmetry. Second Embodiment

Next, a transformer 200 according to a second embodiment of the present invention is explained. The transformer 200 includes inductors 201 and 202. The inductors 201 and 202 are disposed on top of one another and thereby form one transformer. FIG. 10 is a plane view showing the configuration of the inductor 201 of the transformer 200 according to the second embodiment of the present invention. The inductor 201 includes lines W21 to W24 and intersections 21 to 23. The lines W21 to W24 are concentrically arranged and have an opened ring shape.

The intersection 21 is an intersection that is formed by combining the intersections 11 and 12 of the transformer 100 according to the first embodiment into one intersection, and moving its position. The intersection 23 corresponds to the intersection 13 of the transformer 100 according to the first embodiment. Both of the intersections 21 and 23 are disposed at or near one corner of the inductor 201 having a square shape.

As a result, an inductor having a path “port P1→line W24→intersection 23→intersection 21→line W22→line W21→intersection 21→line W23→intersection 23→port P2” is formed. In other words, similarly to the first embodiment, the line W21, which is the innermost line, is connected to a line located immediately outside the innermost line W21, i.e., the line W22 and also connected to a line located two lines outside the innermost line W21, i.e., the line W23. Further, the outermost line W24 is connected to a line located two lines inside the line W24, i.e., the line W22.

Although an example in which there are four lines is explained above with reference to FIG. 10 as in the case of the first embodiment, the number of lines is preferably three or more in order to provide the function as an inductor. Note that to ensure the electrical symmetry, the number of lines is preferably an even number. Further, for cases where there are an arbitrary number of lines, the only requirement is that the innermost line should be connected to a line located immediately outside the innermost line and a line located two lines outside the innermost line, and each of the remaining lines should be connected to a line located two lines outside that line.

FIG. 11 is a plane view showing a configuration of the transformer 200 according to the second embodiment of the present invention. The transformer 200 has such a structure that the inductor 201 is put on top of the inductor 202, which is rotated by 180°. In this example, the inductors 201 and 202 have the common center axis. The inductor 202 has a structure that is obtained by replacing the upper layer of the inductor 201 with its lower layer. The lines W25 to W28 of the inductor 202 correspond to the line W21 to W24 of the inductor 201. The intersections 24 and 26 of the inductor 202 correspond to the intersections 21 and 23 of the inductor 201. The ports P3 and P4 of the inductor 202 correspond to the ports P1 and P2 of the inductor 201.

That is, in the transformer 100, it is possible to provide a horizontal space 2^{1/2} times as long as the internal diameter D of the inductor between the intersections 21 and 24. Therefore, it is possible to increase the distance between the intersections in comparison to the transformer 100. Accordingly, it is possible to more reliably prevent the intra-layer dielectric breakdown, which could otherwise occur in the insulating layer located between the wiring layers L2 and L3.

### Third Embodiment

Next, a transformer 300 according to a third embodiment of the present invention is explained. Similarly to the transformer 100 according to the first embodiment, the transformer 300 includes inductors 101 and 102. The inductors 101 and 102 are disposed on top of one another and thereby form one transformer. However, the method in which the inductors 101 and 102 are disposed on top of one another of the transformer 300 is different from that of the transformer 100. The configuration of the inductors 101 and 102 is similar to that of the first embodiment, and therefore its explanation is omitted here.

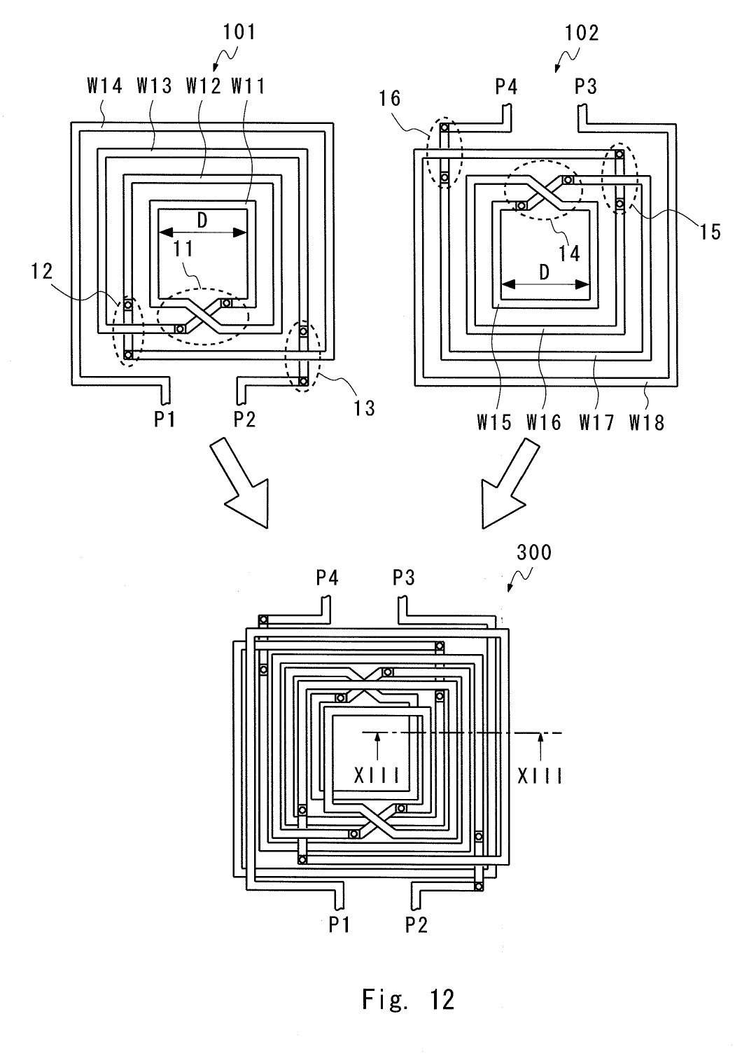

FIG. 12 is a plane view showing a configuration of the transformer 300 according to the third embodiment of the present invention. The transformer 300 has such a structure that the inductor 101 is put on top of the inductor 102, which is rotated by 180°. However, the area in which the line of the inductor 101 lies on top of the line of the inductor 102 is minimized. Specifically, the inductor 101 is disposed in such a manner that the inductor 101 is displaced from the inductor 102 by a distance equal to one half of the line formation pitch A in both the horizontal direction and the vertical direction (in the drawing) in FIG. 12. That is, the center axis of the inductor 101 is displaced from that of the inductor 102.

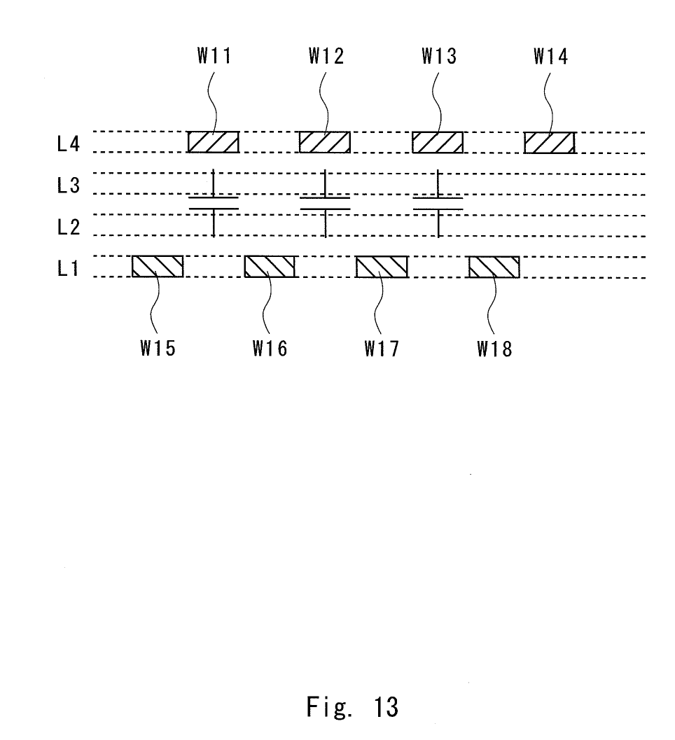

FIG. 13 is a cross section taken along the line XIII-XIII of FIG. 12, and shows a cross-sectional structure of the transformer 300. In the transformer 300, the lines W11 to W14 of the inductor 101 are formed in the uppermost wiring layer L4. The lines W15 to W18 of the inductor 102 are formed in the lowermost wiring layer L1. As shown in FIG. 13, the lines W11 to W14 are disposed so that they do not overlap the lines W15 to W18. In general, as shown in FIG. 13, parasitic capacitances occur between wiring layers disposed in a laminated structure. However, in the transformer 300, by disposing the lines W11 to W14 so that they do not overlap the lines W15 to W18, it is possible to lower the parasitic capacitances.

Therefore, according to the configuration of this embodiment, it is possible to provide a transformer capable of not only achieving the same advantageous effects as those of the transformer 100, but also lowering the parasitic capacitance.

### Fourth Embodiment

Next, a transformer 400 according to a fourth embodiment of the present invention is explained. The transformer 400 includes inductors 401 and 402. The inductors 401 and 402 are disposed on top of one another and thereby form one transformer.

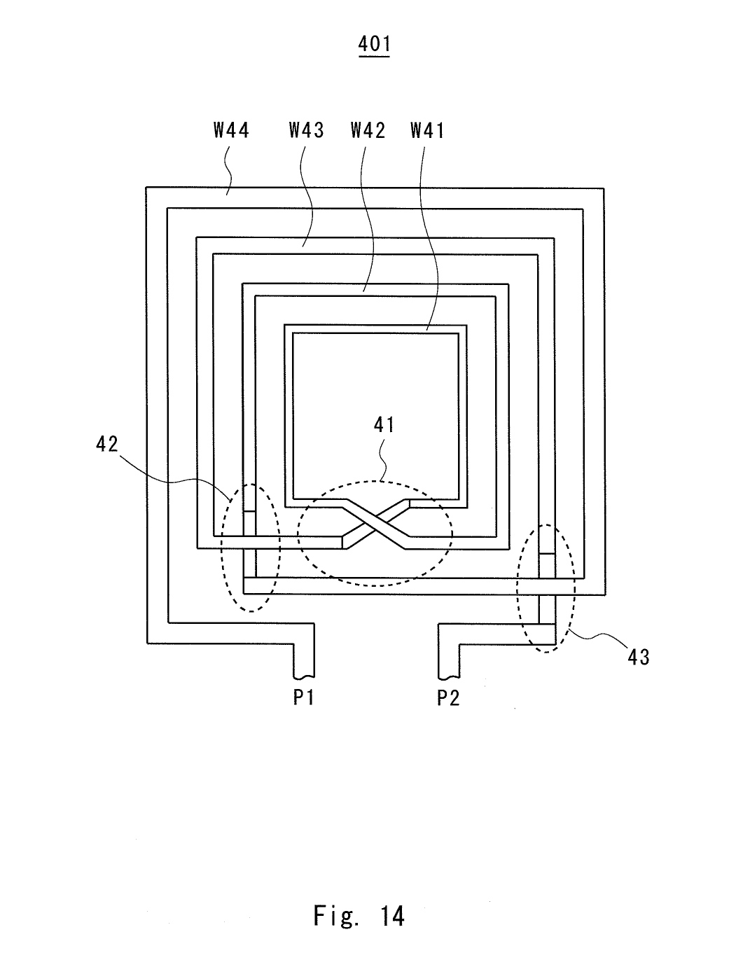

FIG. 14 is a plane view showing the configuration of the inductor 401 of the transformer 400 according to the fourth embodiment of the present invention. The inductor 401 is a modified example of the inductor 101 according to the first embodiment. The lines W41 to W44 of the inductor 401 correspond to the line W11 to W14 of the inductor 101. The intersections 41 to 43 of the inductor 401 correspond to the intersections 11 to 13 of the inductor 101.

The widths of the lines W11 to W14 are different from one another. Specifically, the more inner side the line is located, the narrower the width becomes. FIG. 14 shows an example in which the width of lines becomes narrower in the direction from the line W14 to the line W11. Note that the inductor 402 has also a similar configuration to that of the inductor 102 according to the first embodiment except that the widths of lines are different from one another. Therefore, its explanation is omitted here. Further, the transformer 400 is similar to the transformer 100 except that the inductors 101 and 102 are replaced by the inductors 401 and 402, and therefore its explanation is omitted here.

In the transformer 400, it is possible to reduce the area occupied by the inductors by gradually narrowing the lines. Therefore, according to the configuration of this embodiment, it is possible to reduce the size of the transformer.

Although FIG. 14 shows an example in which the width of lines becomes narrower in the direction from the line W14 to the line W11, it is just an example. For example, it is possible to adopt a configuration in which the width of lines becomes narrower in the direction from the line W11 to the line W14. Further, it is also possible to change the line width in a random manner. However, when a line becomes narrower, the resistive component of the line becomes larger. Therefore, in order to minimize the increase in the resistive component, it is preferable to narrow lines located in an inner side because their length is shorter.

### Fifth Embodiment

Next, a transformer 500 according to a fifth embodiment of the present invention is explained. The transformer 500 includes inductors 501 and 502. The inductors 501 and 502 are disposed on top of one another and thereby form one transformer.

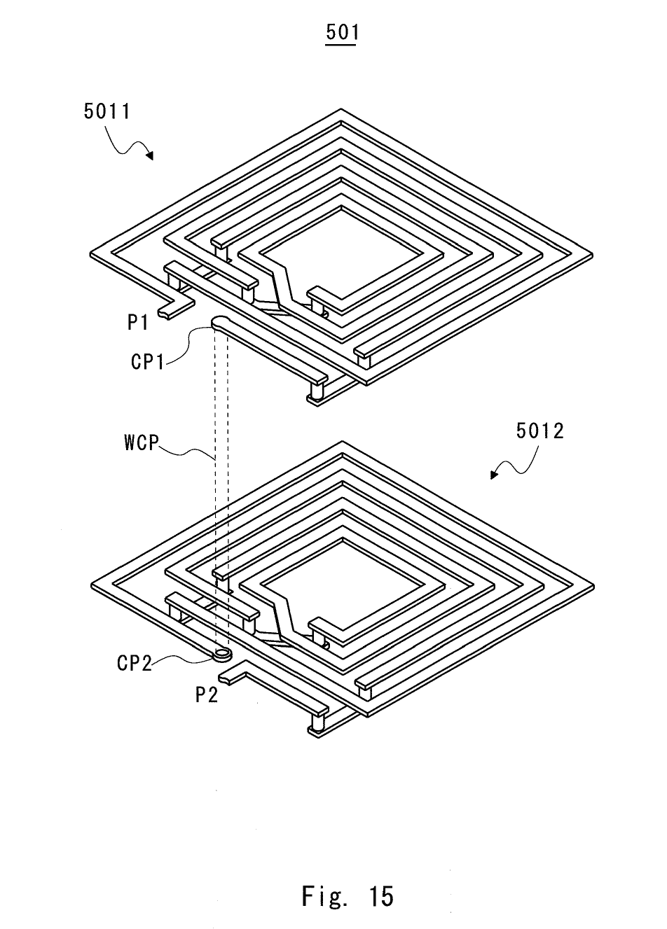

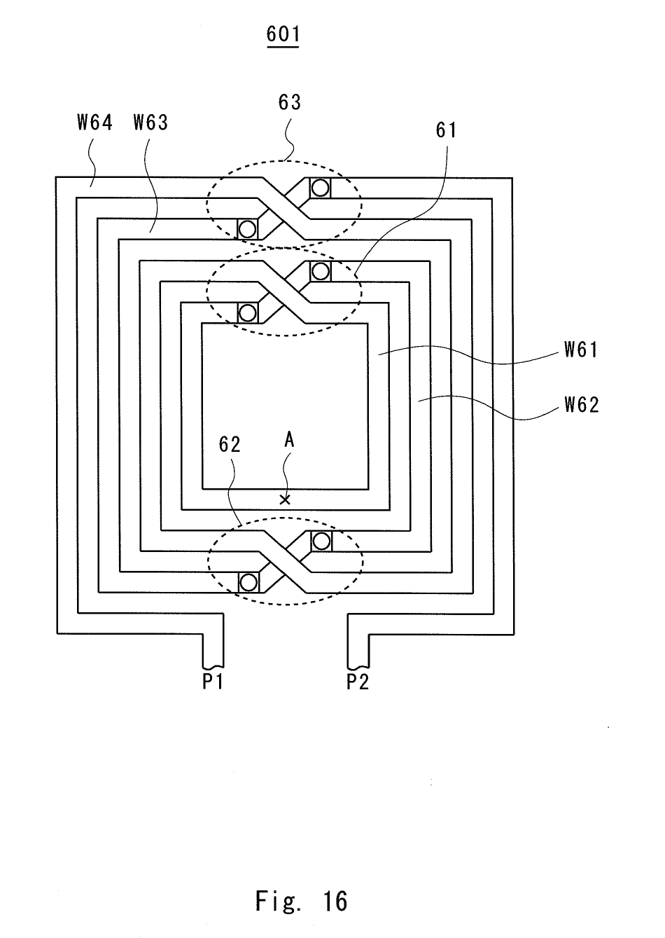

FIG. 15 is a plane view showing the structure of the inductor 501 of the transformer 500 according to the fifth embodiment of the present invention. The inductor 501 is an inductor having a double structure. That is, the inductor 501 has a structure that is obtained by connecting two inductors 101 according to the first embodiment in series. As shown in FIG. 15, the inductor 501 a first inductor section 5011 and a second inductor section 5012. Each of the first inductor section 5011 and the second inductor section 5012 has a similar configuration to that of the inductor 101. However, in the first inductor section 5011, the port P2 of the inductor 101 is replaced by a connection point CP1. In the second inductor section 5012, the port P1 of the inductor 101 is replaced by a connection point CP2. Further, the connection point CP1 is connected to the connection point CP2 through a line WCP. Further, the inductor 502 has a similar structure to that of the inductor 501, and therefore its explanation is omitted here.

According to the configuration of this embodiment, it is possible to increase the inductance by connecting a plurality of inductors in series without increasing the area occupied by the inductors. As a result, it is possible to reduce the size of the transformer.

Further, since the parasitic capacitance between the first inductor section 5011 and the second inductor section 5012 can be reduced, it is possible to advantageously improve the tolerance to the common mode noise.

Note that the present invention is not limited to the above-described embodiments, and these embodiments can be modified as appropriate without departing from the spirit and scope of the present invention. For example, although the inductors 101 and 102 are used in the transformer 300 according to the third embodiment, this configuration is just an example. That is, the inductors 201 and 202, the inductors 401 and 402, or the inductor 501 can be also used.

Although the fourth embodiment is explained by using the inductor 401, which is a modified example of the inductor 101, this configuration is also just an example. As a modified example of the inductor 201, it can be constructed as an inductor in which the line width of the inductor 201 or 501 is changed. Further, an inductor that is obtained by changing the line width of the inductor 201 or 501 can be also applied to the third embodiment.

Although an example in which the first inductor section 5011 and the second inductor section 5012, each of which has a similar configuration to that of the inductor 101, is explained in the fourth embodiment, this configuration is just an example. That is, the inductor 201, 401, and an inductor obtained by changing the line width of the inductor 201 can be also applied to the fourth embodiment.

Although configuration examples in which the wiring layer L2 adjoins the wiring layer L3 with an interlayer insulating film interposed therebetween are explained in the above-described embodiments, these configurations are just an example. That is, a plurality of insulating films may be formed between the wiring layer L2 and the wiring layer L3. Alternatively, a layer(s) other than the insulating layer that is electrically isolated from the wiring layers L2 and L3 may be formed between the wiring layer L2 and the wiring layer L3.

Although the above-described embodiments are explained by using square-shaped inductors as an example, the shape of the inductor is not limited to this shape. The shape of an inductor may be any arbitrary polygon other than square, or may be a circuit or an ellipse. When an inductor has a polygon shape, the intra-layer dielectric breakdown can be advantageously prevented by disposing an intersection(s) of one of the inductors at one of two vertices having the largest distance therebetween and disposing an intersection(s) of the other inductor at the other of the two vertices. Alternatively, the intra-layer dielectric breakdown can be advantageously prevented by disposing an intersection(s) of one of the inductors at one of two sides having the largest distance therebetween and disposing an intersection(s) of the other inductor at the other of the two sides.

The first to fifth embodiments can be combined as desirable by one of ordinary skill in the art.

While the invention has been described in terms of several embodiments, those skilled in the art will recognize that the invention can be practiced with various modifications within the spirit and scope of the appended claims and the invention is not limited to the examples described above.

Further, the scope of the claims is not limited by the embodiments described above.

Furthermore, it is noted that, Applicant's intent is to encompass equivalents of all claim elements, even if amended later during prosecution.

What is claimed is:

1. A transformer comprising:
a first inductor; and
a second inductor disposed so as to be opposed to the first inductor, the second inductor being rotated around a center axis by 180° with respect to the first inductor, wherein
the first inductor comprises:
a plurality of lines concentrically formed in a first wiring layer, the plurality of lines having an opened ring shape; and
a first intersection formed in a first area, the first area being one of two areas divided by a line passing through a center axis of the first and second inductors, the first intersection connecting a first line among the plurality of lines of the first inductor with a second line located two lines outside the first line,
the first intersection comprises:
a first connection line formed in a second wiring layer below the first wiring layer; and
a first interlayer line that connects the first line with the first connection line and connects the second line with the first connection line,
in an innermost first intersection, an innermost line and a line immediately outside the innermost line are formed in the first wiring layer in a continuous manner,
the second inductor comprises:
a plurality of lines concentrically formed in a third wiring layer below the second wiring layer, the plurality of lines having an opened ring shape; and
a second intersection formed in a second area, the second area being another of the two areas divided by the line passing through the center axis of the first and second inductors, the second intersection connecting a third line among the plurality of lines of the second inductor with a fourth line located two lines outside the third line,
the second intersection comprises:
a second connection line formed in a fourth wiring layer between the second wiring layer and the third wiring layer; and
a second interlayer line that connects the third line with the second connection line and connects the fourth line with the second connection line, and
in an innermost second intersection, an innermost line and a line immediately outside the innermost line are formed in the third wiring layer in a continuous manner.

2. The transformer according to claim 1, wherein the plurality of lines of the first inductor and the plurality of lines of the second inductor are formed as polygonal-shaped opened rings that are concentrically formed around a center axis.

3. The transformer according to claim 2, wherein
the first intersection is formed adjacent to a first vertex of the polygonal shape,
the second intersection is formed adjacent to a second vertex of the polygonal shape, and
the first and second vertices have a largest distance therebetween in comparison to distances between other vertices.

4. The transformer according to claim 2, wherein
the first intersection is formed on a first side of the polygonal shape,
the second intersection is formed on a second side of the polygonal shape, and
the first and second sides have a largest distance therebetween in comparison to distances between other sides.

5. The transformer according to claim 1, wherein the plurality of lines of the first inductor and the plurality of lines of the second inductor are formed as circular-shaped or elliptic-shaped opened rings that are concentrically formed around a center axis.

6. The transformer according to claim 1, wherein the center axis of the first inductor is displaced from the center axis of the second inductor.

7. The transformer according to claim 1, wherein
widths of the plurality of lines of the first inductor are different from one another, and
widths of the plurality of lines of the second inductor are different from one another.

8. The transformer according to claim 7, wherein width of the plurality of lines of the first inductor and the plurality of lines of the second inductor becomes narrower in a direction from an outer side to an inner side.
